(19) United States
(12) Patent Application Publication
(10) Pub. No.: US 2017/0193100 A1
(43) Pub. Date: Jul. 6, 2017

(54) MUSIC DISTRIBUTION SYSTEM

(71) Applicant: MARCUS BOWERY, SCHENECTADY, NY (US)

(72) Inventor: MARCUS BOWERY, SCHENECTADY, NY (US)

(21) Appl. No.: 15/400,678

(22) Filed: Jan. 6, 2017

Related U.S. Application Data
(60) Provisional application No. 62/275,481, filed on Jan. 6, 2016.

(51) Int. Cl. G06F 17/30; H04L 12/58; H04L 29/08

(52) U.S. Cl. CPC G06F 17/30749; H04L 67/306; H04L 51/32; H04L 67/22; G06F 17/30752; G06F 17/30769

(57) ABSTRACT

Disclosed herein is a method, along with a system and computer program product for performing a method. The method includes receiving, by a processor, data from an input device, analyzing, by the processor, the data and determining, by the processor, a time period and genre of music that a user desires to be provided. The method further includes providing, by the processor, audio files having the time period and the genre of music that the user desires to be provided.

### CROSS-REFERENCE TO RELATED APPLICATIONS

This application claims priority to U.S. Provisional Application No. 62/275,481, having a filing date of Jan. 6, 2016, and titled, “Distributed Formatted Music In Year and Genre,” the entire contents of which are hereby incorporated by reference.

### TECHNICAL FIELD

The subject matter disclosed herein generally relates to software and applications for storing and playing music. More particularly, the invention provides music distribution, providing and/or presenting system that sorts and stores music, for example by genre and by year.

### BACKGROUND

Various existing methods exist to distribute music to online consumers. Some services provide a searchable database of songs to download permanently, while others provide streaming services that allow users to listen to music through an online application. Music distribution services may be provided by a web page that is accessible by the consumer on a web browser. Music distribution services may also be provided by an application downloaded by the consumer. However millions of songs exist, and it is often difficult to determine which songs a particular consumer desires to listen to, stream, or download. Sometimes, it is even the case that consumers would like a system to make suggestions as to which songs the consumer would likely desire to listen to, stream or download.

Thus, a user-friendly application and related software that facilitates sorting, storing, and playback of music by, for example, both genre and year and which creates playlists based upon these criteria would be well received in the art.

### BRIEF DESCRIPTION

An embodiment of the present invention relates to a method, and associated computer system and computer program product, for distributing music to a user. A processor of a computing system receives data from an input device, analyzes the data, determines a time period and genre of music that a user desires to be provided, and provides audio files having the time period and the genre of music that the user desires to be provided.

### BRIEF DESCRIPTION OF THE DRAWINGS

FIG. 1 depicts a block diagram of a music distribution system, in accordance with embodiments of the present disclosure.

FIG. 2 depicts a flow chart of a method for distributing music, in accordance with embodiments of the present disclosure.

FIG. 3 depicts a flow chart of a method for distributing music, in accordance with embodiments of the present disclosure.

FIG. 4 depicts a flow chart of a method for distributing music, in accordance with embodiments of the present disclosure.

FIG. 5 depicts a flow chart of a method for distributing music, in accordance with embodiments of the present disclosure.

FIG. 6 illustrates a block diagram of a computer system for the music distribution system of FIG. 1, capable of implementing methods for distributing music of FIG. 3, in accordance with embodiments of the present disclosure.

FIG. 7 depicts a cloud computing environment, in accordance with embodiments of the present disclosure.

FIG. 8 depicts abstraction model layers, in accordance with embodiments of the present disclosure.

### DETAILED DESCRIPTION

A detailed description of the hereinafter described embodiments of the disclosed apparatus and method are presented herein by way of exemplification and not limitation with reference to the Figures.

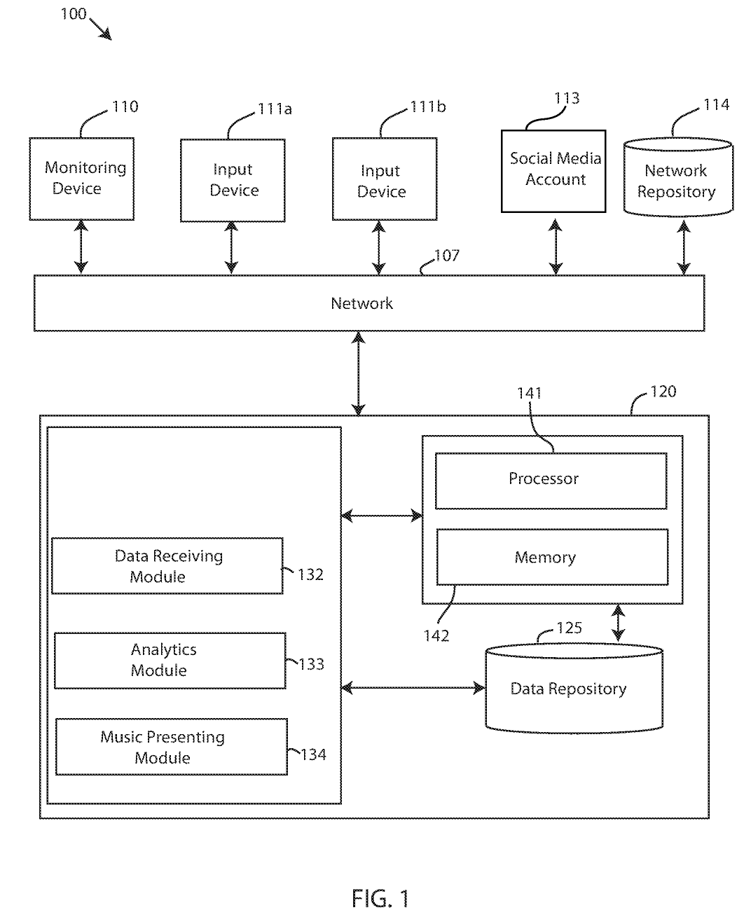

Referring to the drawings, FIG. 1 depicts a block diagram of a music distribution system 100, in accordance with embodiments of the present invention. “Music distribution system 100” hereinafter means any music, song, or audio distribution, providing, or presenting system, or any system that provides music, songs or audio in either a downloadable and/or stream-able format, such as digital radio, video and/or music streaming or the like.

In one embodiment the music distribution system 100 may comprise a monitoring device 110 and input device 111a, 111b communicatively coupled to a computing system 120 over a network 107. The number of input device 111a, 111b connecting to computer system 120 over network 107 may vary from embodiment to embodiment. As shown in FIG. 1, the monitoring device 110 and/or the input device 111a, 111b may transmit data or information related to song, music or playlist selection that a user may desire to hear or download, received from the monitoring device 110 and/or input device 111a, 111b by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture. The network 107 may also be configured to allow access various social media accounts such as a social media account 113. For example, in one embodiment, the network 107 may be the Internet, and the computing system 120 may be able to access social media account 113 through the network 107.

In some embodiments, the network 107 may further comprise, in addition to the computer system 120, monitoring device 110 and input device 111a, 111b, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging spectator data sent by the monitoring device 110 and/or input device 111a, 111b to generate both historical and predictive reports regarding a particular user. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Referring still to FIG. 1, embodiments of the computing system 120 may receive the data or information related to song, music or playlist selection that a user may desire to hear or download from the monitoring device 110 and/or input device 111a, 111b which may be positioned within an environment shared by the user, worn by the user, or otherwise disposed in a location that can result in obtaining this user data. Input device 111a, 111b may be a sensor, an input device, or any input mechanism. For example, input devices 111a, 111b may be a biometric sensor, a wearable sensor, an environmental sensor, a camera, a camcorder, a microphone, a peripheral device, a computing device, a mobile computing device, such as a smartphone or tablet, facial recognition sensor, voice capture device, and the like. Embodiments of input device 111a, 111b may also include a heart rate monitor used to track a current or historical average heart rate of the user; wireless-enabled wearable technology, such as an activity tracker or smartwatch that tracks a heart rate; a blood pressure monitor; a perspiration sensor; and other wearable sensor hardware. Further embodiments of input device 111a, 111b not specifically listed herein may be utilized to collect spectator data.

Further embodiments of input means 111a, 111b may include one or more input devices or input mechanisms, including one or more cameras positioned proximate the user or within an environment shared by the user. The one or more environment cameras may capture image data or video data of a user, including a posture, facial expressions, perspiration, muscle activity, gestures, etc. Embodiments of the input device 111a, 111b may also include one or more microphones positioned nearby the user to collect audio relating to the user, and other hardware input devices, such as an audio conversion device, digital camera or camcorder, voice recognition devices, graphics tablet, a webcam, VR equipment, mouse, touchpad, stylus, and the like, which may help gauge a reaction by the user to a song or collection of songs Further embodiments of input device 111a, 111b may include a mobile computing device, such as a smartphone or tablet device, which may run various applications that contain data about the user. For example, a user's smartphone may be used as a sensor, and may also utilize the device's camera, microphone, and other embedded sensors to send information to the computing system 120. Moreover, embodiments of input device 111a, 111b may encompass other input mechanisms, such as a user computer that may send information to the computing system 120, wherein the user computer may be loaded with software programs that are designed to track an emotional output of the user.

The computing system 120 may receive data or information related to song, music or playlist selection that a user may desire to hear or download, in the manner and accordance to the methods described hereinbelow, from the network 107. The computing system 120 may process, analyze, compute, and return playlist, music, song suggestions, and the like, in the manner consistent with the methods described herein. In one embodiment, the data repository 125 may be configured to store music and/or songs for playback upon a user's command. The data repository 125 may be configured to further store playlist information for users in accordance with the methods described herein. Further, the data repository 125 may be configured to store the data or information related to song, music or playlist selection that a user may desire to hear or download that has been received by the computing system 120 across the network 107.

In one embodiment, a method 200 for distributing music may include a step 201 of sorting, by a processor, stored song data or information, or music, by both genre and release year. For example, referring back to FIG. 1, the computing system 120 (and accompanying processor 141) sort song data or information stored in the data repository 125, the network repository 114, or elsewhere. The method 200 may include a step 202 of using attributes, by the processor, and creating a predetermined playlist or song/music arrangement along with a step 203 of presenting or providing the predetermined playlist, song/music arrangement to a user or user device. In one embodiment, an attribute may be genre information, date information, or other similar information applicable to songs or music. In one embodiment, a created predetermined playlist may include all songs released in the year 1990 which are categorized as being within the rhythm and blues (R&B) genre. The step 202 may include creating the predetermined playlist or song/music arrangement by arranging songs of the same genre in chronological order, i.e. by release date within the given year, or alphabetically by title within a year. Other sorting arrangements within the genre-and-year playlists may be implemented, such as alphabetically by band, by popularity, by chart position at various times, or by other individualized or customizable rankings. It should be understood that the method 200 may also be applicable to other genres, such as country, pop, rap, hip hop, rock and roll, metal, alternative, jazz, classical, or even future genres that are not yet invented or created at present.

The step 202 may include creating a predetermined playlist that includes some or all songs of a specific genre from a plurality of years. The playlist may be stored by the computing system 120 and processor 141, for example it may be stored in the data repository 125, the network repository 114, or another location. For example, a playlist may include some or all songs in the hip hop genre from the years 2000-2004. The processor may then organize the songs according to additional sorting arrangements. For example, the method 200 may include a step 204 of sorting, by the processor, according to additional criteria within date-based and/or yearly sorting.

This sorting of songs, or generation of playlists, by year may be desirable to users for several reasons. For example, songs from a particular genre and year combination may hold sentimental value for an individual. A married couple may wish to be able to hear a playlist of the pop genre songs from the year they were married, the year in which they became engaged, or the year they met. Similarly, a parent, grandparent, godparent, sibling, other relative, or friend may wish to hear a playlist of all of the songs in a specific genre from the year an individual is born. Other life events for which an individual would like to hear music may also be easily identified, such as other anniversaries, graduations, milestone birthdays, vacations, promotions, deaths, etc.

Alternatively, a user may wish to hear popular songs from a specific period of their history. For example, a user may wish to hear all rock and roll songs released during the years that they were in high school, or all songs in a different genre released while they were in college. In response, the processor may be configured to create a predetermined playlist with these songs. This playlist may then be sorted as discussed above, with various sorting criteria able to be applied to the songs. Further, the sorting parameters may again be applied to the group of songs returned as a whole, or to the songs falling within the respective individual years.

Sorting by year within a specific genre may further be desirable to musical experts, scholars, and aficionados. For example, a student or devoted fan of the jazz genre may wish to hear playlists of all of the jazz music released in a given year so that they may compare it to jazz music of another, different year. The student may alternatively wish to compare jazz music of a specific year to rhythm and blues (R&B) music from the same year. The student or fan may thus be able to learn about how varying styles, motifs, themes, and other musical qualities have varied with time and across different genres. Further, by listening to multiple playlists comprising songs of different years or of songs released in the same year but in different genres, the user may be able to develop insights into and/or more fully appreciate some genres' traditions, history, development, and evolution; understand how time and other factors have influenced certain styles; or compare the development of differing genres over time.

In order to generate playlists, in one embodiment the processor may receive input information provided by a user. For example, the method 200 of distributing music may include a step 205 of inputting, by a user device, date information such as important years, dates, or timeframes to be used as a date attribute for sorting and playlist development by the processor. The method 200 may include a step 206 of inputting, by the user, specific genres of music to correlate with some or all of the time periods. It should be understood that steps 205 and 206 may be conducted prior to, during, or after the steps 201 and 202 of sorting and creating a predetermined playlist or song arrangement. The steps of inputting may be accomplished by the input device 111a, 111b, or the like. Further, the data inputted by the user may be processed initially by the data receiving module 132 in one embodiment.

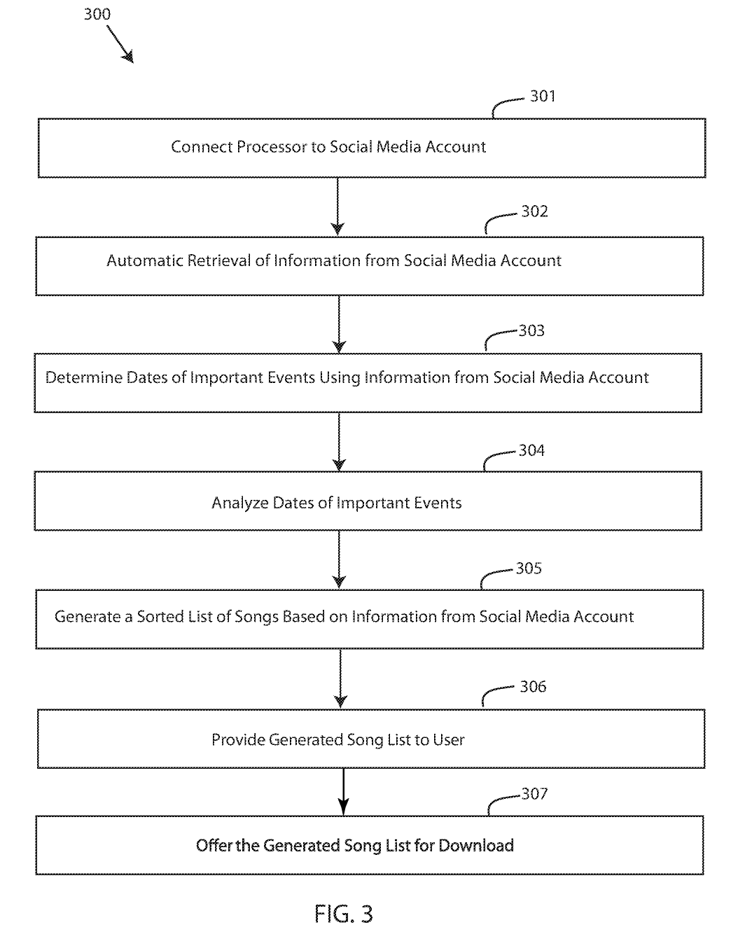

In another embodiment, shown in FIG. 3, a method 300 of distributing music is shown. The method 300 includes a step 301 of connecting a processor to a social media account, such as social media account 113 shown in FIG. 1. The step of connecting the processor to the social media account may be accomplished through a network 107 as shown in FIG. 1. Further, in one embodiment, the network 107 may be the Internet, thus allowing the processor to be connected to various social media accounts, such as social media account 113, normally accessible on the Internet. The method 300 may include a step 302 of automatically retrieving, by the processor, information from the social media account. In this step 302, for example, the application or processor may collect the user's date of birth, age, gender, etc., from the social media profile. Again, this step may be accomplished by access to the network 107 (such as the Internet) which may allow the processor to access various social media accounts normally accessible on the Internet. Still further, the retrieved information may be initially processed by the data receiving module 132. Further, a step 303 may include determining, by the processor, the date of important events by postings, statuses, comments, events, and other social media features that are associated with the social media account of a user. In one embodiment, the step of determining dates and importance of dates may be performed by the analytics module 133. Popular well-constructed social media platforms such as Facebook are typically already configured to store and display information related to a user's graduation, work anniversary, wedding anniversary, birth of children, and the like. The method 300 may include a step 304 of analyzing, by the processor, the date related information from the social media platform. The step of analyzing date related information may also be accomplished by the analytics module 133. The method 300 may also include a step 305 of generating a sorted list of songs based on the information provided by the social media platform. For example, the step 305 may include using, by the processor, information gathered from a social media account database to determine appropriate years that the user would consider important and applying the data related to these determined years when determining a streaming playlist suggestion. The method may include a step 306 of providing and/or presenting this generated song list to a user device, for example, via a song-streaming interface. The method may alternatively include a step 307 of offering this generated song list for a user to download permanently. The step of offering the generated song list to the user may be performed by the music presenting module 134 in one embodiment.

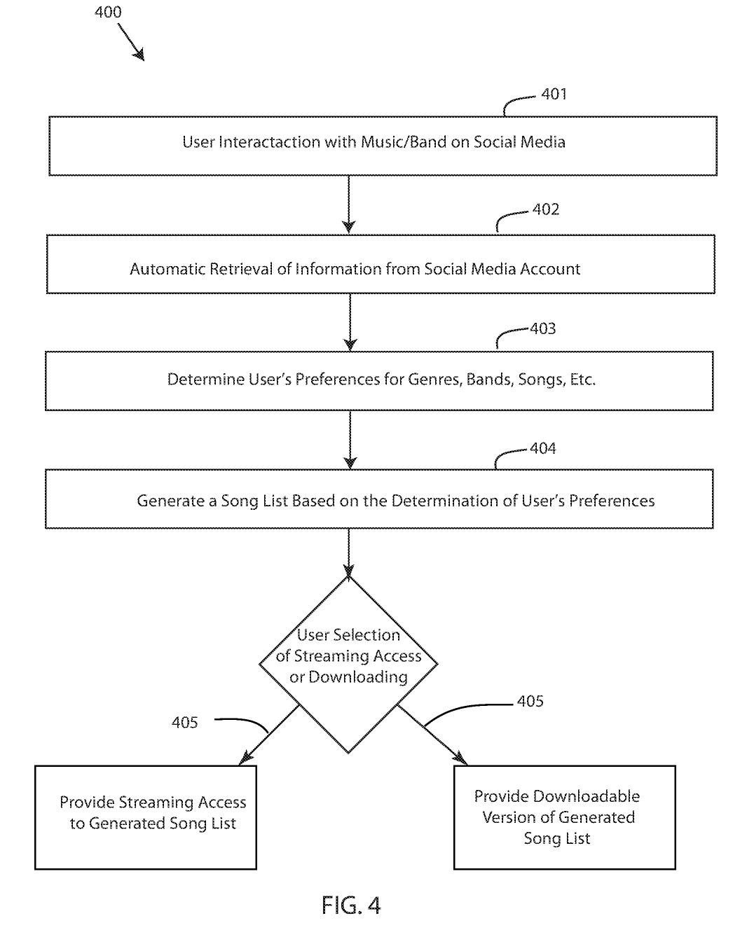

In another embodiment shown in FIG. 4, a method 400 of distributing music may include a step 402 of automatically retrieving information from a social media account pertaining to what genres the user would appreciate. The step of automatically retrieving information from a social media account may be accomplished by connection to the network 107 (for example, the Internet) as has been described above. In one embodiment, at a step 401, a social media user may “like”, “follow”, “retweet”, or otherwise interact with bands and musical groups that they like or with whom they identify. Further, at step 401, social media users may post lyrics, quotes, concert schedules, pictures, videos, etc., from these groups, or “like”, “comment on”, or otherwise interact with similar posts by their friends. This interaction may be retrieved by the processor as has been described and may be initially processed by the data receiving module 132. Further, the method 400 may include a step 403 of determining by the processor, after retrieving or otherwise being provided with this information at the step 402, what genres, bands, songs, or the like, what a user would want to listen to. This step may be accomplished by the analytics module 133. The method may include a step 404 of generating a song list based on the determining, by the processor, what a user would want to listen to. The step of generating the song list may be accomplished by the analytics module 133 or by a separate component of the computing system 120. The method may include a step 405 of providing and/or presenting this generated song list to a user device, for example, via a song-streaming interface. This step may be accomplished by the music presenting module 134 in one embodiment. The method may alternatively include a step 405 of offering this generated song list for a user to download permanently. This step may also be accomplished by the music presenting module 134 as has been described. It should be understood that the methods 400 and 300, and other methods described herein, may be combined into a single method that incorporates some or all of the steps outlined herein.

In one embodiment, the method 300, 400 may be provided by the social media platform itself. For example, Facebook® may implement the present method in order to provide music streaming or download services to an individual directly from the a user's Facebook® account. In other embodiments, the method 300, 400 may include partnering with a social media platform to be provided data or information by the social media platform for use in generating music streaming, download, or presenting services in accordance with the methods described herein.

In a further embodiment, the methods 300, 400 may include step(s) of generating and providing users with interactive games to play, such as trivia games based upon the genre; year of the song; or other feature of the song, such as lyrics, release date, band information, etc. Methods may further include connecting users through these games to allow users to compete against each other in these games.

In a still further embodiment of the methods 300, 400, the processor may use the provided information to target advertising toward the user, either by offering music, or related goods or services to the user. In one embodiment, the methods may include using, by the processor, only the genre or the year in order to target this advertising. In using the year for targeted advertising to the user, methods may include determining that an individual who chooses to listen to songs from a certain year will likely be of a specific age range and advertise products toward the user accordingly. Further, methods may include determining, by a processor, that regardless of age, a user who appreciates music from this year is likely to also have an affinity for certain products, goods, services, or other items. Similar determinations may be made based upon the genre information.

While methods may include having songs and music already saved, stored, or otherwise available for the user, in a further embodiment methods may include users uploading, sharing, or otherwise importing songs and music into a cloud-based storage system. In such embodiments, methods may include verifying the song title, lyrics, genre, year, and/or other information or it may rely on the user's designations. Methods may also include placing the uploaded song or music into a predetermined playlists based on the year and genre. This cataloguing of uploaded music may be done by analysis of already uploaded songs or by methods of analyzing lyrics and music to determine the author, band, song title, and other information.

In order to play the music or songs for the user, methods may include organizing songs and/or music into playlists. Such playlists may be predetermined and unchangeable by the user, or methods may include providing choice in the playlist, such as the ability to skip songs, replay a previous song, remove songs from the list, or alter the order of the songs in other ways. The playlist of songs may also be visible or invisible to the user. When visible, the user may be able to see upcoming songs. Methods may further include providing entirely random playback of songs within a given playlist, thus giving the user control of only the genre and year criteria.

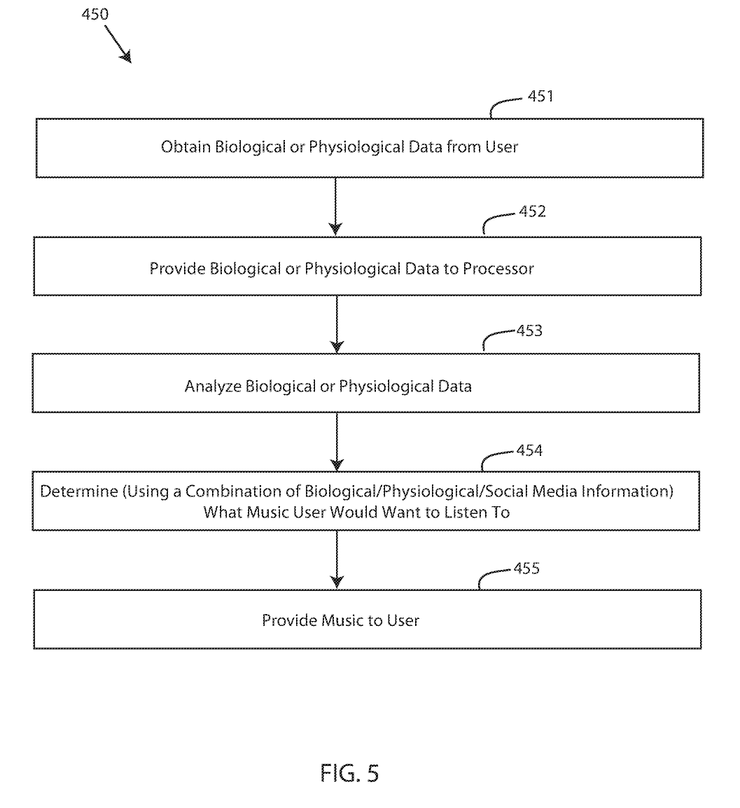

Another embodiment of a method 450 is shown in FIG. 5. The method 450 may include a step 451 of obtaining biological or physiological data from a user from a sensor or other data collecting device. The sensor or other data collection device may be a monitoring device, such as monitoring device 110. The method 450 may include a step 452 of providing the biological or physiological data to a processor. For example, in one embodiment, the biological or physiological data may be provided to the data receiving module 132. The method 450 may include a step 453 of analyzing this biological or physiological data, by the processor, for example by the analytics module 133. The method 450 may further include a step 454 of determining, by the processor, using a combination of the biological or physiological data and the social media information described in methods 300, 400 hereinabove, of what music a user would want to listen to. Again, this step may be performed by the analytics module 133, or by another component of the computing system 120. For example, the step 454 may include determining a genre of music and/or a date, year, decade, etc. of music.

In one embodiment, for example, the biological sensor or data collecting device may determine that a user is working out because of the collection of heart rate information, step information or the like. This information may be combined with the social media information in order to make the determination at step 454 of what music to present, provide or distribute to a user. Similarly, the biological sensor or data collecting device may determine that a user is sleeping or about to fall asleep because of the collection of heart rate information, retina scan information or the like. Appropriate music may be provided to the user in this situation. In still other embodiments, biological information may be used to determine the genre and/or date, year, decade, etc. of music a user might desire to be provided. For example, it may be determined that certain combinations of biological information may cause a person to desire or be receptive to a particular genre, or time of music.

Overall, the method 450 may include a step 455 of providing, distributing or otherwise presenting the music to the user based on the determining of step 454. This step may be performed by the music presenting module in one embodiment.

In a still further embodiment, the monitoring device 110 may be a component of a radio system, audio system, or entertainment system, such as a radio, CD player, mp3 player, iPod®, cell phone, car radio, etc., collectively referred to as a music playback device. The monitoring device may be configured to collect information regarding songs/music played by the music playback device, in one embodiment. Further the music playback device may transfer the collected information to the processor, such as to the data receiving module 132. The collected information may be used by the processor, such as by the analytics module 133 in one embodiment, to determine what type of music a user may prefer to listen to, or to create additional playlists. In a further embodiment, the monitoring device 110 may be a part of a car radio system, a car audio system, a car entertainment system, etc. The monitoring device 110 may collect information regarding songs played directly by the car radio system (for example, by radio tuning, CD reading, etc.), or which are played by the car radio system on a pass-through basis, such as by a Bluetooth connection to another device or similar configuration.

Still further, the monitoring device 110 may include a microphone or other sound collecting device, in one embodiment, and may collect information regarding songs/music played in the environment of the music playback device. This collected information may be used by the data receiving module 132 and the analytics module 133 as has been described above.

Referring back to FIG. 1, embodiments of the computing system 120 may include a data receiving module 132, an analytics module 133, and a music or song providing module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the computing system 120 may also include the data receiving module 132. Embodiments of the data receiving module 132 may include one or more components of hardware and/or software program code for receiving related to song, music or playlist selection that a user may desire to hear or download monitoring device 110, and/or the input device 111a, 111b. The data receiving module 132 may receive information related to song, music or playlist selection that a user may desire to hear, or download hardware information from the monitoring device 110. For example, the monitoring device 110 may utilize cameras and sensors to obtain physical expressions of the spectator, as described above, the data of which may be transmitted to the computing system 120 over the network 7. Embodiments of the data receiving module 132 may organize, classify, or otherwise categorize the data or information related to song, music or playlist selection that a user may desire to hear, or download as needed by the computing system 120.

Embodiments of the computing system 120 may further include an analytics module 133 for analyzing data related to song, music or playlist selection that a user may desire to hear or download and determining which playlist or music, songs or audio information to provide, present or distribute to a user. Embodiments of the analytics module 133 may refer to configurations of hardware, software program code, or combinations of hardware and software programs, capable of analyzing data received from the monitoring device 110 and/or input device 111a, 111b and applying one or more data models to discover, identify, interpret the data or information in the manner described herein. The analytics module 133 may rely on applications of statistics, computer programming, and the like, of the data collected and received by the analytics module 133 in order to determine insight into the user's desire or inclination to listen to a particular music, song, or audio file. Embodiments of the analytics module 133 may analyze or otherwise interpret this information sufficient detail by the monitoring device 110.

Embodiments of the computing system 120 may further include a music presenting module 134. The music presenting module 134 may be a song, audio, or audio/video presenting module. Embodiments of the music presenting module 120 may include configurations of hardware, software program code, or combinations of hardware and software programs, capable of presenting music, songs, audio or audio/video files and/or information to a user. For example, the music presenting module 134 may provide music, music suggestions, download suggestions, or the like, using a digital radio web browser interface to a user in accordance with the embodiments described. In other embodiments, the music presenting module 134 may provide music, music suggestions, download suggestions, or the like, through a downloadable application provided to the users. In still other embodiments, the music presenting module 134 may be a module included as part of a social networking system (not shown). For example, the music presenting module 134 may provide music, music suggestions, download suggestions, streaming suggestions, or actually provide streaming music or audio directly to users that are logged into a social media account on a web browser or application.

Referring still to FIG. 1, embodiments of the computer system 120 may be equipped with a memory device 142 which may store the data or information related to song, music or playlist selection that a user may desire to hear or download, and the like, and a processor 141 for implementing the tasks associated with the music distribution system 100.

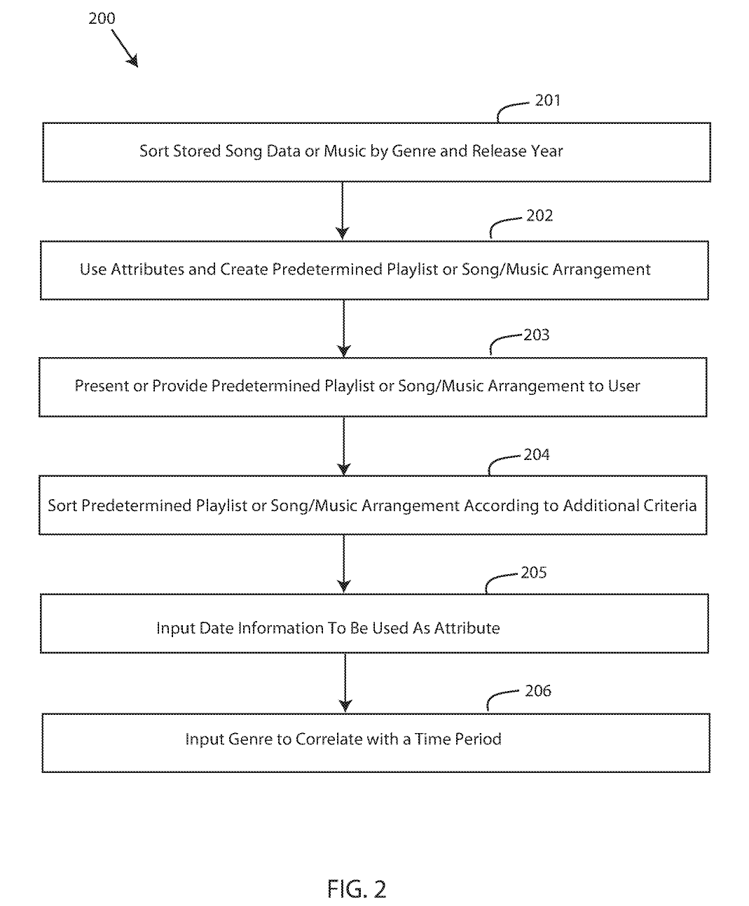

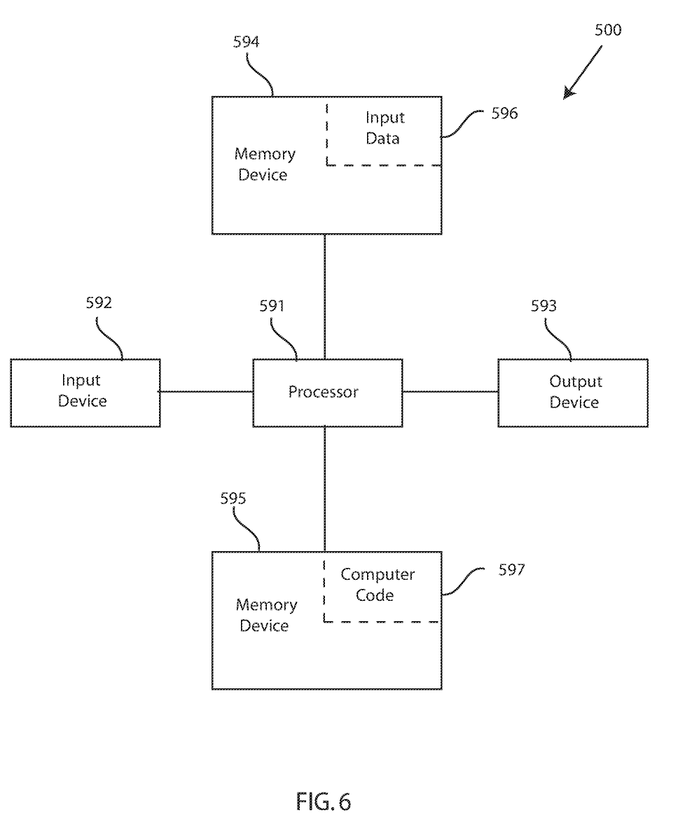

FIG. 6 illustrates a block diagram of a computer system 500 that may be included in the system of FIG. 1 and for implementing the methods of FIGS. 2-5 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for distributing music, in the manner prescribed by the embodiments of FIGS. 2-5 using the music distribution system of FIG. 1, wherein the instructions of the computer code 597 may be executed by processor 591 via memory device 595. The computer code 597 may include software or program instructions that may implement one or more algorithms for implementing the methods distributing, providing and presenting music, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to distributing, providing, and presenting music. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to perform the methods described herein. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of distributing, providing, and presenting music. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for distributing, providing and presenting music.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

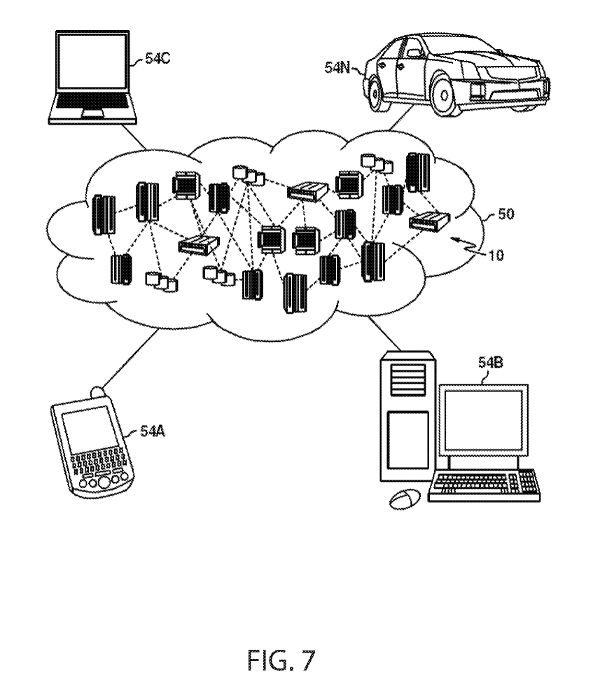

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser).

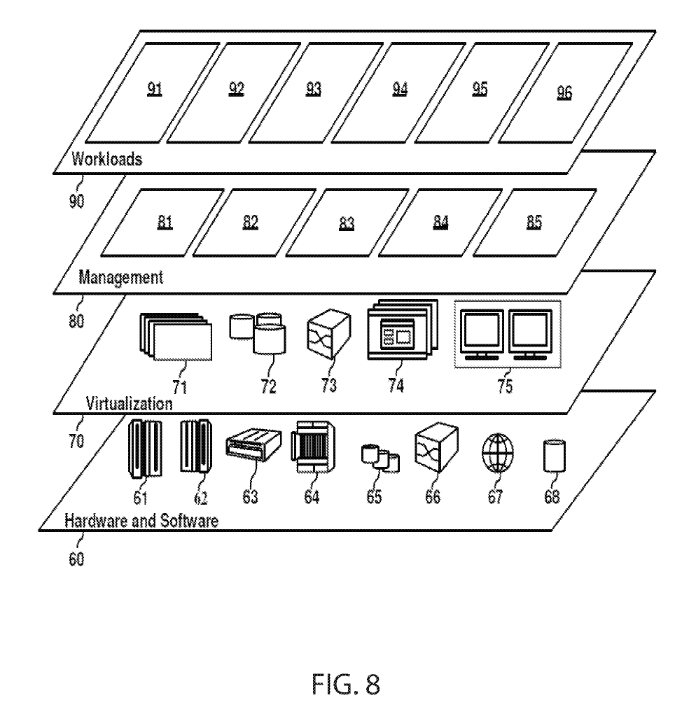

Referring now to FIG. 8, a set of functional abstraction layers provided by cloud computing environment 50 (see FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: social media access 91; song determination 92; song sorting 93; 94; song list generation 95; and song access management for providing the song/music to the user 96, and the like.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of providing music, the method comprising:
receiving, by a processor of a computing system, data from an input device;
analyzing, by the processor, the data;
determining, by the processor, a time period and genre of music that a user desires to be provided; and
providing, by the processor, audio files having the time period and the genre of music that the user desires to be provided.

2. The method of claim 1, further comprising connecting, by the processor, the processor to a social media account, wherein the data is received from the social media account.

3. The method of claim 2, further comprising:
determining, by the processor, events using the data received from the social media account; and
wherein the determining the time period by the processor is based on the determining of the events.

4. The method of claim 2, further comprising:
determining, by the processor, user preferences for music genres using the data received from the social media account;
wherein the determining the genre by the processor is based on the determining of preferences of music.

5. The method of claim 4, wherein the data relates to a stored history of a user action selected from the group consisting of:
liking a social media page;
following a social media page;
posting lyrics to a social media page;
posting quotes to a social media page;
posting a concert schedule to a social media page;
commenting on a social media page;
posting a picture to a social media page; and
posting a video to a social media page.

6. The method of claim 1, wherein the data is biological or physiological data, and wherein the input device is a biological or physiological sensor.

7. The method of claim 6, wherein the determining, by the processor, the time period and the genre of music that the user desires to be provided includes determining, by the processor, that the user is at least one of asleep and working out.

8. The method of claim 1, wherein the input device is a vehicle audio control interface, wherein the processor is a processor of a vehicle, and wherein the data relates to a stored history of user information selected from the group consisting of:
a radio selection;
a musical song played;
an audio file copied into a database; and
a musical song played on a radio station.

9. A computer system, comprising:
a processor;
a memory device coupled to the processor;
one or more sensors coupled to the processor; and
a computer readable storage device coupled to the processor, wherein the storage device contains program code executable by the processor via the memory device to implement a method for distributing music, the method comprising:
receiving, by a processor of a computing system, data from an input device;
analyzing, by the processor, the data;
determining, by the processor, a time period and genre of music that a user desires to be provided; and
providing, by the processor, audio files having the time period and the genre of music that the user desires to be provided.

10. The computer system of claim 9, wherein the method further comprises:
connecting, by the processor, the processor to a social media account, wherein the data is received from the social media account.

11. The computer system of claim 10, wherein the method further comprises:
determining, by the processor, events using the data received from the social media account; and
wherein the determining the time period by the processor is based on the determining of the important events.

12. The computer system of claim 10, wherein the method further comprises:
determining, by the processor, user preferences for music genres using the data received from the social media account;
wherein the determining the genre by the processor is based on the determining of preferences of music.

13. The computer system of claim 12, wherein the data relates to a stored history of a user action selected from the group consisting of:
liking a social media page;
following a social media page;
posting lyrics to a social media page;
posting quotes to a social media page;
posting a concert schedule to a social media page;
commenting on a social media page;
posting a picture to a social media page; and
posting a video to a social media page.

14. The computer system of claim 9, wherein the data is biological or physiological data, and wherein the input device is a biological or physiological sensor.

15. The computer system of claim 14, wherein the determining, by the processor, the time period and the genre of music that the user desires to be provided includes determining, by the processor, that the user is at least one of asleep and working out.

16. The computer system of claim 9, wherein the input device is a vehicle audio control interface, wherein the processor is a processor of a vehicle, and wherein the data relates to a stored history of user information selected from the group consisting of:
a radio selection;
a musical song played;
an audio file copied into a database; and
a musical song played on a radio station.

17. A computer program product, comprising a computer readable hardware storage device storing a computer readable program code, the computer readable program code comprising an algorithm that when executed by a computer processor of a computing system implements a method for distributing music, comprising:
receiving, by the processor, data from an input device;
analyzing, by the processor, the data;
determining, by the processor, a time period and genre of music that a user desires to be provided; and
providing, by the processor, audio files having the time period and the genre of music that the user desires to be provided.

18. The computer program product of claim 17, the method further comprising connecting, by the processor, the processor to a social media account, wherein the data is received from the social media account.

19. The computer program product of claim 18, the method further comprising:
determining, by the processor, user preferences for music genres using the data received from the social media account;
wherein the determining the genre by the processor is based on the determining of preferences of music.

20. The computer program product of claim 19, wherein the data relates to a stored history of a user action selected from the group consisting of:
liking a social media page;
following a social media page;
posting lyrics to a social media page;
posting quotes to a social media page;
posting a concert schedule to a social media page;
commenting on a social media page;
posting a picture to a social media page; and
posting a video to a social media page.
